(19) United States
(12) Patent Application Publication
(10) Pub. No.: US 2007/0058023 A1
(43) Pub. Date: Mar. 15, 2007

(54) Image forming apparatus and method for controlling the same

(75) Inventor: Yong-Jun Yoo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/418,032

(22) Filed: May 5, 2006

(30) Foreign Application Priority Data
Sep. 15, 2005 (KR) 2005-86376

(51) Int. Cl. B41J 2/01

(52) U.S. Cl. 347/104

(57) ABSTRACT

An image forming apparatus includes a main body, an image forming section disposed in the main body to form an image on paper, and a reciprocation section for enabling the paper to exit and re-enter the main body while the image is formed by the image forming section. A driver section moves paper to the reciprocation section and senses movement of the paper to determine whether a paper reciprocation space is clear of obstacles to reciprocate the paper. Thus, prior to image formation, it is sensed whether both the reciprocation space allowing the paper to exit and re-enter and a loading space allowing the paper on which the image is formed to be loaded are sufficiently clear of obstacles to provide efficient image formation.

### CROSS-REFERENCE TO RELATED APPLICATION

This application claims the benefit under 35 U.S.C. § 119(a) of Korean Patent Application No. 2005-86376, filed Sep. 15, 2005 the entire disclosure of which is hereby incorporated by reference.

### BACKGROUND OF THE INVENTION

1. Field of the Invention

The present invention relates to an image forming apparatus. More particularly, the present invention relates to an image forming apparatus and a method of controlling the same capable of checking whether a reciprocation space of paper is clear of obstacles to reciprocate the paper during image formation.

2. Description of the Related Art

Generally, an image forming apparatus transfers an image signal to a recording medium, such as a sheet of printing paper, in the form of a visible image according to a digital signal input from a computer or scanner. Image forming apparatuses may be classified as laser printers, which form an image using an electrostatic latent image; ink-jet printers, which form an image using ink injection; and sublimation printers, which use thermal transfer.

Currently, commercialized photo printers print photographic images captured by digital cameras by applying a printing technique, such as an ink jet method, a dye sublimation thermal transfer method, or a direct thermal method.

Among the above photo printers, the dye sublimation thermal transfer image forming apparatus forms an image by disposing a film-like ribbon covered with ink between a thermal head and paper, and then transferring the ink sublimated in a specified pattern by the thermal head to the paper via the ribbon.

The dye sublimation thermal transfer image forming apparatus sequentially transfers monochromatic images of yellow, magenta and cyan three times to obtain full color.

When the image forming apparatus is not sufficient in size, the paper repeatedly exits and re-enters the apparatus during the transfer process. Because the current dye sublimation thermal transfer image forming apparatus has become small enough for a user to conveniently carry, the paper is inevitably exposed to the outside while forming the image.

Thus, to guarantee smooth in-and-out operation of the paper during image formation, sufficient space should be clear of obstacles in a direction where the paper travels.

This is difficult unless the user has full knowledge of such functional features through a user's manual in advance and then appropriately adjusts a position of the image forming apparatus.

However, it is more likely that the user does not have full knowledge of such functional features in advance. When the user proceeds with image formation without securing sufficient space, the paper may be damaged while exiting and re-entering the image forming apparatus.

Accordingly, a need exists for an improved image forming apparatus that ascertains whether sufficient reciprocation space is available to reciprocate paper while an image is being formed thereon.

### SUMMARY OF THE INVENTION

Therefore, exemplary embodiments of the present invention provide an image forming apparatus and method for controlling the same capable of checking whether a reciprocation space of paper is clear of obstacles to reciprocate the paper during image formation.

Furthermore, exemplary embodiments of the present invention provide an image forming apparatus and method for controlling the same capable of determining whether a reciprocation space of paper is clear of obstacles to reciprocate the paper and then indicate the sensed result to a user.

According to an aspect of the invention, an image forming apparatus includes a main body having an image forming section provided therein to form an image on paper, and a reciprocation section to enable the paper to exit and re-enter the main body while the image is formed by the image forming section. A driver section moves the paper to the reciprocation section and senses movement of the paper to determine whether a paper reciprocation space is clear of obstacles to reciprocate the paper.

The driver section may include a platen roller to transfer the paper, a driving motor to drive the platen roller, and a motor drive to supply the driving motor with power and simultaneously sensing a current of the driving motor to sense a state of transfer of the paper by the platen roller.

Furthermore, the motor drive may include a reference voltage generator to generate a reference voltage of the driving motor, a voltage amplifier to amplify the voltage generated by the reference voltage generator to supply the amplified voltage to the driving motor, and a current detector to sense the current of the driving motor.

Alternatively, the driver section may include a platen roller to transfer the paper, a driving motor to drive the platen roller, and a motor drive to supply the driving motor with power and simultaneously controlling rotation of the driving motor. An encoder senses the rotation of the driving motor to sense a state of transfer of the paper by the platen roller.

Furthermore, the image forming section may include a ribbon cartridge having a wound ribbon arranged with yellow, cyan, magenta and overcoat regions in sequence. A thermal head has the ribbon disposed in contact with the platen roller and applies heat to the ribbon.

Alternatively, the image forming section may include a ribbon cartridge having a wound ribbon arranged with yellow, cyan, magenta and overcoat regions in sequence. A laser light source has the ribbon disposed in contact with the platen roller and casts light onto the ribbon to generate transfer heat through light-to-heat conversion.

Alternatively, the image forming section may include an ink cartridge that is provided with a thermal driving type ink-jet print head to generate bubbles in ink using a thermal source and ejecting ink droplets by an expansion force of the bubbles.

Alternatively, the image forming section may include an ink cartridge that is provided with a piezo-electric driving type ink-jet print head to eject ink droplets by pressure applied to ink by deformation of a piezo-electric element.

Furthermore, the image forming apparatus may further include a display section to display whether the reciprocation space is clear of obstacles in the main body.

Furthermore, the display section may display a request to check whether the reciprocation space is clear of obstacles.

Furthermore, the image forming apparatus may further include a control section in the main body to input confirmation of whether the reciprocation space is clear of obstacles.

Furthermore, the image forming apparatus may further include an alarm section to generate an alarm when the paper reciprocation space is not clear of obstacles.

According to another aspect of the invention, an image forming apparatus includes a main body, a ribbon cartridge provided in the main body and having a wound ribbon, a heating member to apply heat to one surface of the ribbon, and a platen roller for supporting the other surface of the ribbon and fed paper. A driving motor drives the platen roller to transfer the paper. A reciprocation opening is formed at one side of the main body and allows paper to exit and re-enter the main body during image formation. A motor drive supplies the driving motor with power and simultaneously senses a current of the driving motor to determine whether a reciprocation space of the paper transferred by the platen roller is clear of obstacles.

The motor drive may include a reference voltage generator to generate a reference voltage of the driving motor, a voltage amplifier to amplify the voltage generated by the reference voltage generator to supply the amplified voltage to the driving motor, and a current detector to sense the current of the driving motor.

According to still another aspect of the invention, an image forming apparatus includes: a main body, a ribbon cartridge provided in the main body and having a wound ribbon, a heating member to apply heat to one surface of the ribbon, a platen roller to support the other surface of the ribbon and paper, and a driving motor to drive the platen roller to transfer the paper. A reciprocation opening is formed at one side of the main body and allows paper to exit and re-enter the main body during image formation. A motor drive supplies the driving motor with power and simultaneously controls the driving motor. An encoder senses rotation force of the driving motor to determine whether a reciprocation space of the paper transferred by the platen roller is clear of obstacles.

According to yet another aspect of the invention, a method for controlling an image forming apparatus includes picking up and supplying paper based on input of an image forming command, transferring the picked-up paper toward a reciprocation space where the paper exits and re-enters during image formation, and sensing a state of a driving motor to transfer the paper toward the reciprocation space and determine whether a movement space of the paper exiting and re-entering the reciprocation space is clear of obstacles. An image is formed on the paper when the reciprocation space is clear of obstacles.

Sensing the state may sense a current of the driving motor to determine whether the paper reciprocation space is clear of obstacles.

Alternatively, sensing the state may sense rotation of the driving motor to determine whether the paper reciprocation space is clear of obstacles.

Furthermore, the method may further include displaying whether the paper reciprocation space is clear of obstacles according to the result of determining whether the paper reciprocation space is clear of obstacles in the sensing step.

Furthermore, the method may further include inquiring whether the paper reciprocation space is clear of obstacles when it is determined that the paper reciprocation space is not clear of obstacles in the sensing step.

Furthermore, the method may further include inputting information on checking whether the paper reciprocation space is clear of obstacles.

Furthermore, the method may further include generating an alarm when it is determined that the paper reciprocation space is not clear of obstacles in the sensing step.

According to yet another aspect of the invention, a method for controlling an image forming apparatus includes picking up and supplying paper based on input of an image forming command, transferring the picked-up paper toward a reciprocation space where the paper exits and re-enters during image formation, sensing a current of a driving motor for transferring the paper toward the reciprocation space and determining whether the paper reciprocation space is clear of obstacles; displaying whether the paper reciprocation space is clear of obstacles according to the result of determining whether the paper reciprocation space is clear of obstacles, generating an alarm when the paper reciprocation space is not clear of obstacles, inquiring whether the reciprocation space is clear of obstacles; and inputting information on checking whether the reciprocation space is clear of obstacles. An image is formed on the paper when the reciprocation space is clear of obstacles.

According to yet another aspect of the invention, a method for controlling an image forming apparatus includes picking up and supplying paper based on input of an image forming command, transferring the picked-up paper toward a reciprocation space where the paper exits and re-enters during image formation, sensing rotation of a driving motor to transfer the paper toward the reciprocation space and determine whether the paper reciprocation space is clear of obstacles, displaying whether the paper reciprocation space is clear of obstacles according to the result of determining whether the paper reciprocation space is clear of obstacles, generating an alarm when the paper reciprocation space is not clear of obstacles, inquiring whether the reciprocation space is clear of obstacles, and inputting information on checking whether the reciprocation space is clear of obstacles. An image is formed on the paper when the reciprocation space is clear of obstacles.

Other objects, advantages, and salient features of the invention will become apparent from the detailed description, which, taken in conjunction with the annexed drawings, discloses preferred exemplary embodiments of the invention.

### BRIEF DESCRIPTION OF THE DRAWINGS

These and/or other aspects and advantages of the present general inventive concept will become apparent and more readily appreciated from the following description of exemplary embodiments, taken in conjunction with the accompanying drawings, of which:

FIG. 1 is a perspective view showing a sublimation image forming apparatus according to an exemplary embodiment of the present invention;

FIG. 2 is a block diagram of the sublimation image forming apparatus according to an exemplary embodiment of the present invention;

FIG. 3 is a block diagram of a driver of the sublimation image forming apparatus according to an exemplary embodiment of the present invention;

FIG. 4 is a schematical diagram of the interior of a sublimation image forming apparatus according to an exemplary embodiment of the present invention;

FIG. 5 is a flowchart of the operation of a sublimation image forming apparatus according to an exemplary embodiment of the present invention; and

FIG. 6 is a block diagram of another exemplary embodiment of a driver section in a sublimation image forming apparatus according to another exemplary embodiment of the present invention.

Throughout the drawings, like reference numerals will be understood to refer to like parts, components and structures.

### DETAILED DESCRIPTION OF EXEMPLARY EMBODIMENTS

Reference will now be made in detail to the embodiments of the present invention, examples of which are illustrated in the accompanying drawings. Like reference numerals refer to like elements throughout the drawings. The exemplary embodiments are described below to explain the present invention by referring to the figures.

Much of the terminology used herein was chosen to be descriptive of function but should not be construed as limiting the present invention to specific technical components.

Furthermore, the exemplary embodiments of present invention are described with reference to a sublimation image forming apparatus. However, this is merely one exemplary embodiment and the present invention may be also applied to any suitable image forming apparatus, such as an ink-jet or a laser image forming apparatus.

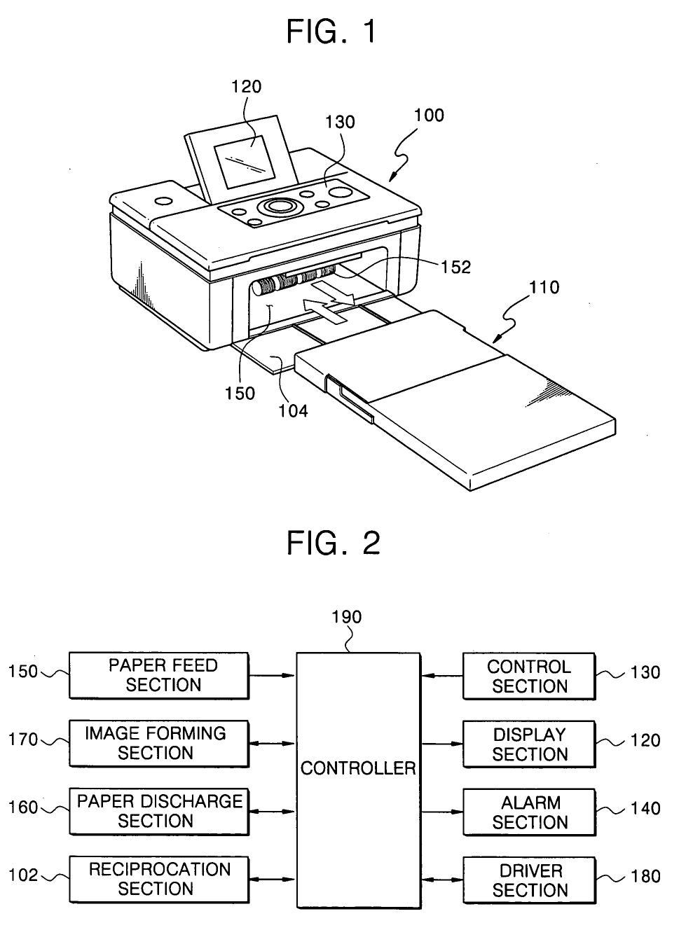

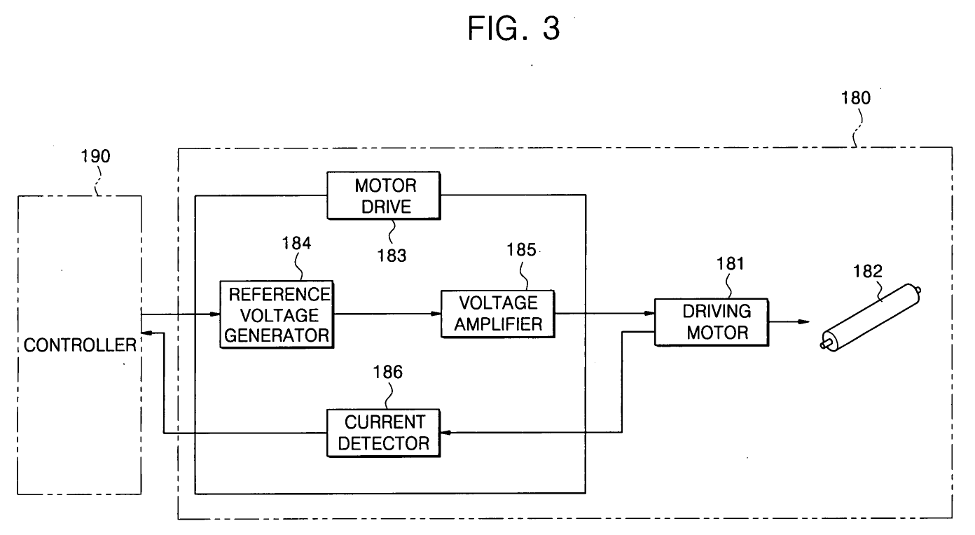

FIG. 1 is a perspective view of a sublimation image forming apparatus according to an exemplary embodiment of the present invention. FIG. 2 is a block diagram of the sublimation image forming apparatus according to an exemplary embodiment of the present invention. FIG. 3 is a block diagram of a driver of the sublimation image forming apparatus according to an exemplary embodiment of the present invention.

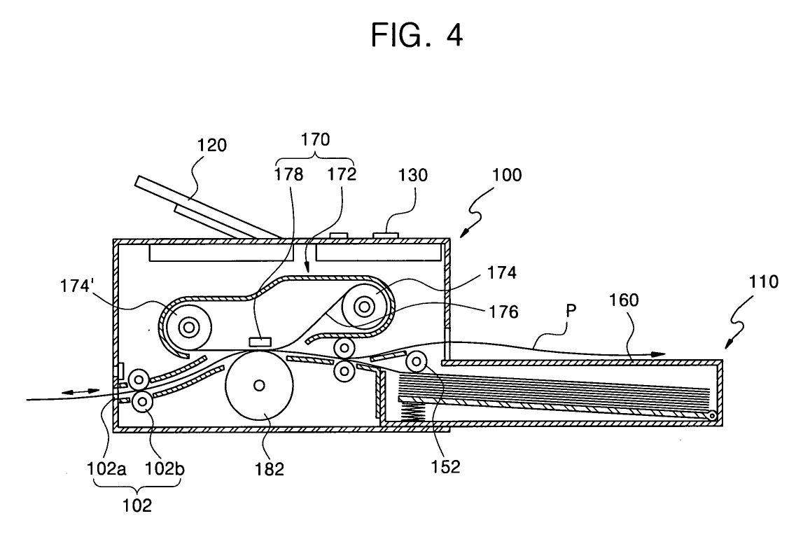

Referring to FIGS. 1, 2, and 3, the sublimation image forming apparatus according to an exemplary embodiment of the present invention has a main body 100 creating an external shape and that forms an image on fed paper P (FIG. 4) in an internal space thereof. A paper feed cassette 110 is coupled to the main body 100 and loaded with many sheets of paper P in an interior thereof.

A display section 120, such as a liquid crystal display, or other suitable display, is provided on an upper portion of the main body 100 to display an operation state of the image forming apparatus. A control section 130 is composed of a plurality of buttons at the front of the display section 120 for controlling the image forming apparatus.

Furthermore, the main body 100 is provided with a separate alarm section 140, including a speaker (not shown) or LED (Light Emitting Device) (not shown), to inform a user of abnormal operation of the image forming apparatus by sound or light.

A paper feed section 150, at which the paper feed cassette 110 for feeding the paper P to an image forming section 170 in the main body 100 is mounted, is provided in the front of the main body 100. The paper feed cassette 110 is detachably mounted to the paper feed section 150.

A paper discharge section 160, to which the paper P on which the image has been formed is discharged, is provided on an upper side of the paper feed section 150. Therefore, the paper P on which the image has been formed is discharged and laid on top of the paper feed cassette 110.

A cover 104 for opening or closing the paper feed section 150 and paper discharge section 160 is hinged to a lower side of the paper feed section 150. A reciprocation section 102, through which the paper P is reciprocated while the image is formed at the image forming section 170, is provided at the rear of the main body 100.

Furthermore, a driver section 180, which transfers the paper P fed by the paper feed section 150, is provided in the main body 100. The paper P fed by the paper feed section 150 is reciprocated through the reciprocation section 102 by the driver section 180. The image forming section 170 forms an image on the paper P transferred by the driver section 180.

The driver section 180 includes a driving motor 181 as a power source for supplying power and a motor drive 183 controlling the driving motor 181. The driving motor 181 cooperates with a platen roller 182 that moves the paper P.

Furthermore, the motor drive 183 is provided with a reference voltage generator 184 for generating a reference voltage according to an input driving signal and a voltage amplifier 185 for amplifying the reference voltage generated by the reference voltage generator 184 to an operating voltage at which the driving motor 181 is operated.

The motor drive 183 is additionally provided with a current detector 186 for measuring current fed back from the driving motor 181, which is operated by the operating voltage amplified at the voltage amplifier 185. The current detector 186 detects the current fed back from the driving motor 181 to sense a load state of the driving motor 181. Generally, the current detector 186 may include a well-known Hall sensor, or other suitable sensor, for detecting a magnitude of current.

Meanwhile, each of the above-mentioned constituents 120 through 180 cooperates with a controller 190, thereby controlling operation of each constituent.

Furthermore, the main body 100 is provided with a universal serial bus (USB) port for inputting image data and connecting external equipment, a memory card slot, and so forth. Additionally, a power connector for supplying external power is provided together.

FIG. 4 schematically shows the interior of the sublimation image forming apparatus according to an exemplary embodiment of the present invention.

Referring to FIG. 4, the image forming section 170 includes a ribbon cartridge 172 that is detachably mounted in the main body 100, and a heating member 178 that applies heat to a ribbon 176 of the ribbon cartridge 172.

The ribbon 176 of the ribbon cartridge 172 is wound between two rollers 174 and 174′. The ribbon 176 has a cyan region, a magenta region, a yellow region and an overcoat arranged in turn.

Therefore, the cyan region, magenta region, yellow region and overcoat are sequentially sublimated onto the paper P by the heating member 178 to form an image on the paper P.

Excluding the overcoat, the sequence in which the cyan region, magenta region, and yellow region are arranged may be changed, and a black region may be added.

The heating member 178 is located over the ribbon 176. To form the image, the heating member 178 may be a thermal head that directly applies heat to the ribbon 176 or a laser light source from which laser light radiates onto the ribbon 176 to generate transfer heat.

As set forth above, the image forming section 170 of the sublimation image forming apparatus according to an exemplary embodiment of the present invention includes the ribbon cartridge 172 having the ribbon 176 made up of the cyan region, magenta region, yellow region, and overcoat, and the heating member 178 applying the transfer heat to the ribbon 176.

While not shown, an ink-jet image forming apparatus may include an ink cartridge having an ink-jet print head of a thermal driving type or piezo-electric driving type.

The platen roller 182, which supports a bottom side of the paper P and simultaneously transfers the paper, is provided at one side of the image forming section 170. A paper feed roller 152 constituting the paper feed section 150 is installed in front of the platen roller 182.

The platen roller 182 is mounted and rotated reversely by the reversible driving motor 181 to change an image forming direction. The driving motor 181 is typically an ordinary DC motor, but may be any kind of controllable motor.

Furthermore, as set forth above, the driving motor 181 is operated by the motor drive 183, which is controlled by the controller 190. The controller 190 senses a state in which the reciprocation space of the paper P transferred by the platen roller 182 is clear of obstacles with a current measurement value of the driving motor 181 measured at the motor drive 183, and controls the motor drive 183.

Meanwhile, the reciprocation section 102 includes a paper reciprocation opening 102a formed at the rear of the main body 100, and in-and-out rollers 102b allowing the paper to reciprocate through the paper reciprocation opening 102a. The in-and-out rollers 102b are installed not to be independently driven but to allow the paper P to be input and output by the paper P transfer of the image forming section 170.

Operation of the sublimation image forming apparatus according to an exemplary embodiment of the present invention will be described below in detail. Each constituent mentioned below should be understood with reference to the above description and FIGS. 1 to 4.

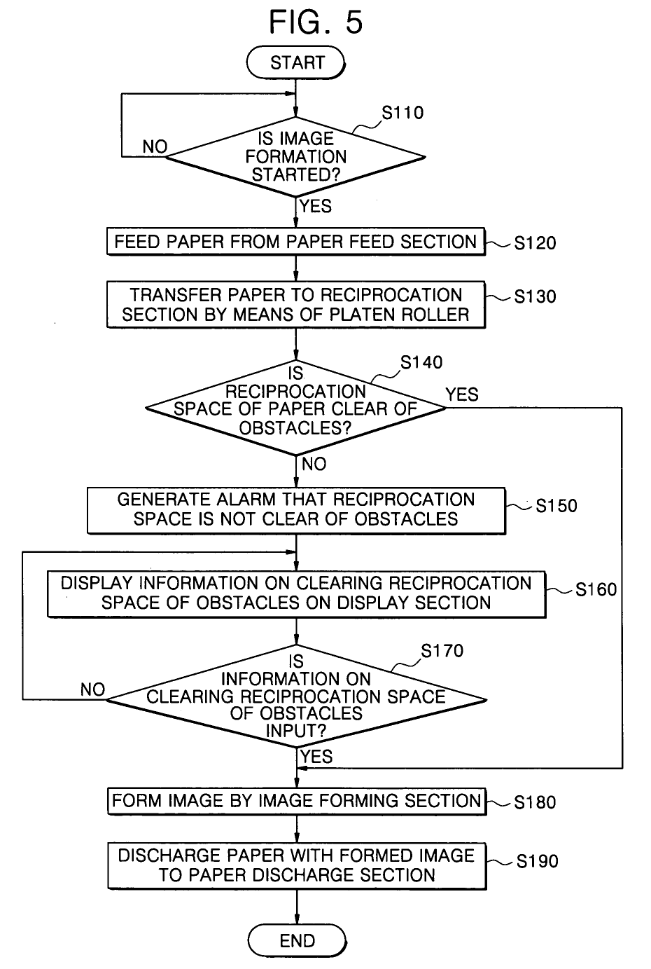

FIG. 5 is a flowchart of the operation of a sublimation image forming apparatus according to an exemplary embodiment of the present invention.

First, as image data is input through a USB port or a memory card slot provided at the main body 100, and then a signal for starting image formation is input by user manipulation, the controller 190 starts the image formation (S110).

As the image formation is started, paper P loaded in the paper feed cassette 110 is picked up by the paper feed roller 152 provided at the paper feed section 150, and then transferred to the image forming section 170 (S120). Then, the transferred paper P is transferred toward the reciprocation section 102 by the platen roller 182 of the image forming section 170 (S130).

The ribbon 176 of the ribbon cartridge 172 provided to the image forming section 170 is disposed between the platen roller 182 and the heating member 178. The paper P fed by the paper feed roller 152 moves into a gap defined between the ribbon 176 and the platen roller 182.

The driving motor 181 driving the platen roller 182 is controlled by the motor drive 183 according to a driving signal generated by the controller 190.

A reference voltage is generated by the reference voltage generator 184 of the motor drive 183 according to the driving signal generated by the controller 190. The generated reference voltage is amplified to an operating voltage of the driving motor 181 by the voltage amplifier 185, and then supplied to the driving motor 181.

Then, the controller 190 senses a jam of the paper P transferred toward the reciprocation section 102 by the platen roller 182 to determine whether the reciprocation space of the paper P is clear of obstacles (S140).

The reason for transferring the paper P toward the reciprocation section 102 before the image is formed on the paper P is to check whether the reciprocation space is clear of obstacles and to prevent loss of the paper and ribbon due to failure to clear the reciprocation space of obstacles.

When there is an obstacle in a movement path of the paper P transferred toward the reciprocation section 102, the paper P transferred toward the reciprocation section 102 comes into contact with the obstacle. Hence, the transferred paper P is obstructed and the driving motor 181 driving the platen roller 182 transferring the paper P is subjected to a sudden overload.

The overload of the driving motor 181 is accompanied by an increase in current through the driving motor 181. The increased current is fed back to the current detector 186 of the motor drive 183 and sensed by the current detector 186, which transmits a signal to the controller 190.

The controller 190 reads the signal transmitted from the current detector 186 and determines whether the reciprocation space of the paper P is clear of obstacles on the movement path of the paper P within the reciprocation section 102.

When the controller 190 determines that the reciprocation space of the paper P is not clear of obstacles, the user is warned, preferably by means of a speaker or lamp of the alarm section 140 (S150).

Furthermore, the controller 190 then enquires through the display section 120 whether the reciprocation space of the paper P has been cleared of obstacles by the user (S160). The controller 190 proceeds with image formation at the image forming section 170 when information that the reciprocation space of the paper P has been cleared of obstacles is input by the user through the control section 130, and maintains a current state if no such information is input (S170).

When it is determined that the reciprocation space of the paper P is clear of obstacles and there are no obstacles in the movement path of the paper P transferred toward the reciprocation section 102, the controller 190 carries out the image formation by the image forming section 170 to form an image on the paper (S180).

When there is no jam of the paper P transferred toward the reciprocation section 102 by the platen roller 182, a current measurement value fed back from the driving motor 181 and detected at the current detector is constant. Therefore, the controller 190 determines that the reciprocation space of the paper P is clear of obstacles by reading the signal of the current detector 186.

Then, the controller 190 discharges the paper P on which the color image is formed by sequential formation of the cyan, magenta, yellow and black colors and the overcoat, onto the top surface of the paper feed cassette 110 through the paper discharge section 160 (S190).

Alternatively, the determination of the reciprocation space of the paper P as mentioned above may be performed in the early step of image formation, or may be repeatedly performed when the paper P is reciprocally transferred through the reciprocation section to sequentially form the cyan, magenta, yellow and black colors and the overcoat on the paper P.

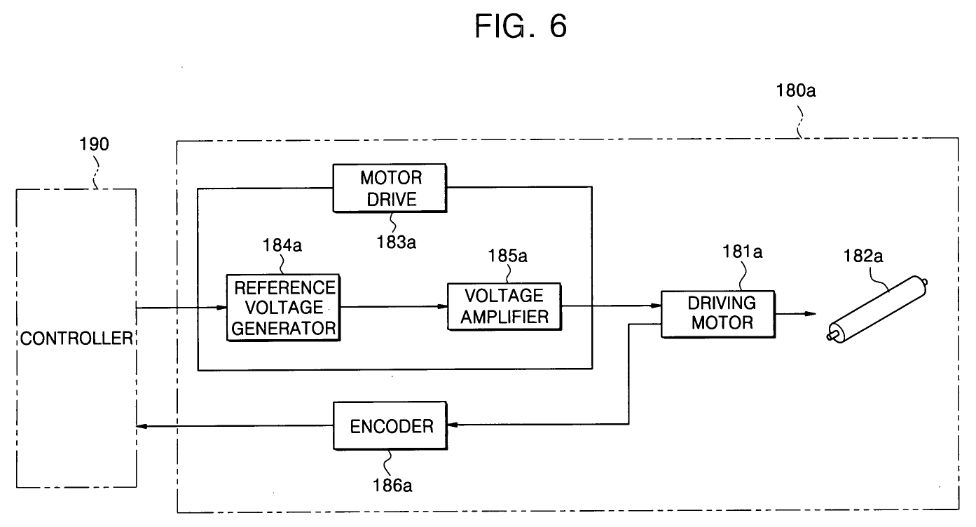

Hereinafter, a driver section 180a in a sublimation image forming apparatus according to another exemplary embodiment of the present invention is described. FIG. 6 is a block diagram of such a driver section 180a in a sublimation image forming apparatus according to another exemplary embodiment of the present invention.

As shown, the driver section 180a is adapted to sense rotation of a driving motor 181a transmitting a driving force to a platen roller 182a and sense a jam of paper transferred by the platen roller.

Components other than the driver section are the same as in the first-described exemplary embodiment and therefore their descriptions are not repeated.

Now, another example of the driver section will be described. As shown, the driver section includes a driving motor 181a, a driving force source for supplying a driving force, and a motor drive 183a for controlling the driving motor 181a. The driving motor 181a is coupled with a platen roller 182a to transfer the paper P.

Furthermore, the motor drive 183a is provided with a reference voltage generator 184a that generates a reference voltage according to an input driving signal, and a voltage amplifier 185a that amplifies the reference voltage generated by the reference voltage generator 184a to an operating voltage at which the driving motor 181a is operated.

The motor drive 183a is additionally provided with an encoder 186a for sensing the rotation of the driving motor 181a operated by the operating voltage amplified at the voltage amplifier 185a. The encoder 186a senses the rotation of the driving motor 181a, thereby sensing a jam of the paper P transferred by the platen roller 182a.

When there is an obstacle in the movement path of the paper P transferred toward the reciprocation section 102 by the platen roller 182a, the paper P bumps into the obstacle and the rotation speed of the driving motor 181a driving the platen roller 182a transferring the paper P momentarily changes.

The momentary change of the rotation speed of the driving motor 181 is sensed by the encoder 186a, which then transmits the sensed signal to the controller 190.

The controller 190 reads the signal transmitted from the encoder 186a to determine whether the paper reciprocation space of the reciprocation section 102 is clear of obstacles along the path of the paper P, and performs image formation accordingly.

As mentioned above, the driving motor 181a of the driver section 180a may be but is not limited to a general DC motor, a stepping motor, and so forth.

For example, exemplary embodiments of the present invention may be applied not only to color image formation but also mono image formation where overcoating is performed, as well as to other image forming apparatuses where the movement path of the paper is necessarily cleared of obstacles.

Furthermore, in the aforementioned exemplary embodiments, the sublimation image forming apparatus is described by way of example. However, the scope of the present invention is not limited to any specific image forming technique. Thus, the present invention may be applied to various image forming techniques, such as a sublimation technique, an ink-jet technique, and other suitable image forming techniques.

Additionally, determination the reciprocation space of the reciprocation section is described above by way of example. However, a discharge space through which paper is discharged may be sensed instead as well.

Therefore, as long as each modification includes the essential constituents of exemplary embodiments of the present invention as its basic constituents, it may be considered to fall within the technical scope of the present invention.

As may be seen from the foregoing, according to the image forming apparatus and method for controlling the same, it is sensed prior to image formation whether both the reciprocation space allowing the paper to exit and re-enter and the loading space allowing the paper to be loaded are sufficiently clear of obstacles during image formation. Thereby, it is possible to improve the efficiency of the image forming apparatus and to reduce paper waste due to damage.

Further, the user is allowed to determine whether or not both the reciprocation space and the loading space of the paper are clear of obstacles and then take appropriate measures. Thus, even when the user does not fully know how to operate the apparatus, images are formed stably. As a result, it is possible to improve the efficiency of the image forming apparatus and reduce damaged paper.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. An image forming apparatus, comprising:
a main body;
an image forming section provided in the main body to form an image on paper;
a reciprocation section for enabling the paper to exit and re-enter the main body while the image is being formed by the image forming section; and
a driver section to move the paper to the reciprocation section and sense movement of the paper to determine whether a paper reciprocation space is clear of obstacles to allow reciprocation of the paper.

2. The image forming apparatus as set forth in claim 1, wherein the driver section includes a platen roller to transfer the paper;
a driving motor to drive the platen roller; and
a motor drive to supply the driving motor with power and simultaneously sense a current of the driving motor to sense a state of transfer of the paper by the platen roller.

3. The image forming apparatus as set forth in claim 2, wherein the motor drive includes a reference voltage generator to generate a reference voltage of the driving motor;
a voltage amplifier to amplify the voltage generated by the reference voltage generator to supply the amplified voltage to the driving motor; and
a current detector to sense the current of the driving motor.

4. The image forming apparatus as set forth in claim 1, wherein the driver section includes a platen roller to transfer the paper;
a driving motor to drive the platen roller;
a motor drive to supply the driving motor with power and simultaneously control rotation of the driving motor; and
an encoder to sense the rotation of the driving motor to sense a state of transfer of the paper by the platen roller.

5. The image forming apparatus as set forth in claim 1, wherein the image forming section includes
a ribbon cartridge having a wound ribbon arranged with yellow, cyan, magenta and overcoat regions in sequence; and
a thermal head having the ribbon disposed in contact with the platen roller to apply heat to the ribbon.

6. The image forming apparatus as set forth in claim 1, wherein the image forming section includes
a ribbon cartridge having a wound ribbon arranged with yellow, cyan, magenta and overcoat regions in sequence; and
a laser light source having the ribbon disposed in contact with the platen roller and casting light onto the ribbon to generate transfer heat through light-to-heat conversion.

7. The image forming apparatus as set forth in claim 1, wherein the image forming section includes
an ink cartridge that is provided with a thermal driving type ink-jet print head to generate bubbles in ink using a thermal source and eject ink droplets by an expansion force of the bubbles.

8. The image forming apparatus as set forth in claim 1, wherein the image forming section includes
an ink cartridge that is provided with a piezo-electric driving type ink-jet print head to eject ink droplets by pressure applied to ink by deformation of a piezo-electric element.

9. The image forming apparatus as set forth in claim 1, further comprising
a display section to display whether the reciprocation space is clear of obstacles in the main body.

10. The image forming apparatus as set forth in claim 9, wherein
the display section displays a request to check whether the reciprocation space is clear of obstacles.

11. The image forming apparatus as set forth in claim 9, further comprising
a control section in the main body to input confirmation of whether the reciprocation space is clear of obstacles.

12. The image forming apparatus as set forth in claim 1, further comprising
an alarm section to generate an alarm when the paper reciprocation space is not clear of obstacles.

13. An image forming apparatus, comprising:
a main body;
a ribbon cartridge provided in the main body and having a wound ribbon;
a heating member to apply heat to one surface of the ribbon;
a platen roller to support the other surface of the ribbon and fed paper;
a driving motor to drive the platen roller to transfer the paper;
a reciprocation opening formed at one side of the main body and allowing the paper to exit and re-enter the main body during image formation; and
a motor drive to supply the driving motor with power and simultaneously sense a current of the driving motor to determine whether a reciprocation space of the paper transferred by the platen roller is clear of obstacles.

14. The image forming apparatus as set forth in claim 13, wherein the motor drive includes
a reference voltage generator to generate a reference voltage of the driving motor;
a voltage amplifier to amplify the voltage generated by the reference voltage generator to supply the amplified voltage to the driving motor; and
a current detector to sense the current of the driving motor.

15. The image forming apparatus as set forth in claim 13, further comprising
a display section to display whether the reciprocation space is clear of obstacles in the main body.

16. The image forming apparatus as set forth in claim 15, wherein
the display section displays a request to check whether the reciprocation space is clear of obstacles.

17. The image forming apparatus as set forth in claim 13, further comprising
a control section in the main body to input confirmation of whether the reciprocation space is clear of obstacles.

18. The image forming apparatus as set forth in claim 13, further comprising
an alarm section to generate an alarm when the paper reciprocation space is not clear of obstacles.

19. The image forming apparatus as set forth in claim 13, wherein
the heating member is a thermal head.

20. The image forming apparatus as set forth in claim 13, wherein
the heating member is a laser light source generating transfer heat through light-to-heat conversion.

21. An image forming apparatus, comprising:
a main body;
a ribbon cartridge provided in the main body and having a wound ribbon;
a heating member to apply heat to one surface of the ribbon;
a platen roller to support the other surface of the ribbon and paper;
a driving motor to drive the platen roller to transfer the paper;
a reciprocation opening formed at one side of the main body and allowing the paper to exit and re-enter the main body during image formation;
a motor drive to supply the driving motor with power and simultaneously control the driving motor; and
an encoder to sense rotational force of the driving motor to determine whether a reciprocation space of the paper transferred by the platen roller is clear of obstacles.

22. The image forming apparatus as set forth in claim 21, further comprising
a display section to display whether the reciprocation space is clear of obstacles in the main body.

23. The image forming apparatus as set forth in claim 22, wherein
the display section displays a request to check whether the reciprocation space is clear of obstacles.

24. The image forming apparatus as set forth in claim 21, further comprising
a control section in the main body to input confirmation of whether the reciprocation space is clear of obstacles.

25. The image forming apparatus as set forth in claim 21, further comprising
an alarm section to generate an alarm when the paper reciprocation space is not clear of obstacles.

26. The image forming apparatus as set forth in claim 21, wherein
the heating member is a thermal head.

27. The image forming apparatus as set forth in claim 21, wherein
the heating member is a laser light source generating transfer heat through light-to-heat conversion.

28. A method of controlling an image forming apparatus, comprising the steps of
picking up and supplying paper based on input of an image forming command;
transferring the picked-up paper toward a reciprocation space where the paper exits and re-enters during image formation;
sensing a state of a driving motor for transferring the paper toward the reciprocation space and determining whether a movement space of the paper exiting and re-entering the reciprocation space is clear of obstacles; and
forming an image on the paper when the reciprocation space is clear of obstacles.

29. The method as set forth in claim 28, wherein in the sensing step
a current of the driving motor is sensed to determine whether the paper reciprocation space is clear of obstacles.

30. The method as set forth in claim 28, wherein in the sensing step
rotation of the driving motor is sensed to determine whether the paper reciprocation space is clear of obstacles.

31. The method as set forth in claim 28, further comprising
displaying whether the paper reciprocation space is clear of obstacles according to the result of determining whether the paper reciprocation space is clear of obstacles in the sensing step.

32. The method as set forth in claim 31, further comprising
inquiring whether the paper reciprocation space is clear of obstacles when it is determined that the paper reciprocation space is not clear of obstacles in the sensing step.

33. The method as set forth in claim 28, further comprising
inputting information on checking whether the paper reciprocation space is clear of obstacles.

34. The method as set forth in claim 28, further comprising
generating an alarm when it is determined that the paper reciprocation space is not clear of obstacles in the sensing step.

35. A method of controlling an image forming apparatus, comprising the steps of
picking up and supplying paper based on input of an image forming command;
transferring the picked-up paper toward a reciprocation space where the paper exits and re-enters during image formation;
sensing a current of a driving motor for transferring the paper toward the reciprocation space and determining whether the paper reciprocation space is clear of obstacles;
displaying whether the paper reciprocation space is clear of obstacles according to the result of determining whether the paper reciprocation space is clear of obstacles;
generating an alarm when the paper reciprocation space is not clear of obstacles;
inquiring whether the reciprocation space is clear of obstacles;
inputting information on checking whether the reciprocation space is clear of obstacles; and
forming an image on the paper when the reciprocation space is clear of obstacles.

36. A method of controlling an image forming apparatus, comprising the steps of
picking up and supplying paper based on input of an image forming command;
transferring the picked-up paper toward a reciprocation space where the paper exits and re-enters during image formation;
sensing rotation of a driving motor for transferring the paper toward the reciprocation space and determining whether the paper reciprocation space is clear of obstacles;
displaying whether the paper reciprocation space is clear of obstacles according to the result of determining whether the paper reciprocation space is clear of obstacles;
generating an alarm when the paper reciprocation space is not clear of obstacles;
inquiring whether the reciprocation space is clear of obstacles;
inputting information on checking whether the reciprocation space is clear of obstacles; and
forming an image on the paper when the reciprocation space is clear of obstacles.
